(19) United States
(12) Patent Application Publication
(10) Pub. No.: US 2015/0169353 A1
(43) Pub. Date: Jun. 18, 2015

(54) SYSTEM AND METHOD FOR MANAGING DATA CENTER SERVICES

(71) Applicants: SERGIO COLLA, SAN JOSE, CA (US); RAJESH SHENOY, SAN JOSE, CA (US); BILL LEUNG, SAN JOSE, CA (US); TUAN NGUYEN, SAN JOSE, CA (US)

(72) Inventors: SERGIO COLLA, SAN JOSE, CA (US); RAJESH SHENOY, SAN JOSE, CA (US); BILL LEUNG, SAN JOSE, CA (US); TUAN NGUYEN, SAN JOSE, CA (US)

(73) Assignee: ALCATEL-LUCENT USA INC., MURRAY HILL, NJ (US)

(21) Appl. No.: 14/502,832

(22) Filed: Sep. 30, 2014

Related U.S. Application Data
(60) Provisional application No. 61/917,841, filed on Dec. 18, 2013.

(51) Int. Cl. G06F 9/455; H04L 29/08

(52) U.S. Cl. CPC G06F 9/45558; H04L 67/10; G06F 2009/4557; G06F 2009/45595

(57) ABSTRACT

Systems, methods, architectures, mechanisms or apparatus to manage virtual and nonvirtual elements in a data center (DC) by correlating necessarily supporting virtual and nonvirtual DC elements, such as the virtual and nonvirtual DC elements necessary to support a VM, a virtual port attaching the VM to an L2 service, a hypervisor supporting the L2 service, an L3 attachment point supporting the L2 service and the L3 service to which the L2 services attached.

### CROSS-REFERENCE TO RELATED APPLICATION

This application claims the benefit of U.S. Provisional Patent Application Ser. No. 61/917,841, filed on Dec. 18, 2013, entitled SYSTEM AND, METHOD FOR MANAGING DATA SESSION ENTITIES, which application is incorporated herein by reference.

### FIELD OF THE INVENTION

The invention relates to the field of network and data center management and, more particularly but not exclusively, to management of real and virtual network elements and services in networks, data centers and the like.

### BACKGROUND

Within the context of a typical data center arrangement, a tenant entity such as a bank or other entity has provisioned for it a number of virtual machines (VMs) which are accessed via a Wide Area Network (WAN) using Border Gateway Protocol (BGP). At the same time, thousands of other virtual machines may be provisioned for hundreds or thousands of other tenants. The scale associated with data center may be enormous; thousands of virtual machines may be created or destroyed each day per tenant demand. Given the increasing scale of data centers, existing network management solutions are becoming strained.

Therefore, there is a need to provide improved efficiency and management of real and virtual network elements/entities such as links, protocols, computation resources, memory resources, services, objects, virtual machines, VM-enabled appliances and so on within a data center environment.

### SUMMARY

Various deficiencies in the prior art are addressed by systems, methods, architectures, mechanisms or apparatus to manage data center resources such that virtual elements as well as nonvirtual elements may be discovered and to correlate to necessary DC elements to provide rapid problem diagnosis and other management functions. For example, various embodiments provide systems, methods, architectures, mechanisms or apparatus to manage virtual and nonvirtual elements in a data center (DC) by correlating necessarily supporting virtual and nonvirtual DC elements, such as the virtual and nonvirtual DC elements necessary to support a VM, a virtual port attaching the VM to an L2 service, a hypervisor supporting the L2 service, an L3 attachment point supporting the L2 service and the L3 service to which the L2 services attached.

One embodiment comprises a method of managing virtual and nonvirtual elements in a data center (DC), comprising determining nonvirtual DC elements and connections necessary to support at least one L3 service; identifying, for the at least one L3 service, at least one access point supporting an L2 service communicating with a virtual machine (VM); correlating the VM with virtual and nonvirtual DC elements and connections necessary to support the L2 service communicating with the VM and the L3 service supporting the L2 service communicating with the VM; and storing, in a non-transient memory, correlation data associated with the VM.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIG. 2 depicts an exemplary management system suitable for use in the system of FIG. 1;

FIG. 3 depicts a flow diagram of methods according to various embodiments;

FIG. 4 graphically depicts a hierarchy of failure relationships of DC entities supporting an exemplary virtualized service useful in understanding the embodiments;

FIGS. 5-9 are flow diagrams of a method according to various embodiments; and

FIG. 10 depicts a high-level block diagram of a computing device suitable for use in performing the functions described herein.

To facilitate understanding, identical reference numerals have been used, where possible, to designate identical elements that are common to the figures.

### DETAILED DESCRIPTION

The invention will be primarily described within the context systems, methods, architectures, mechanisms or apparatus adapted in accordance with particular embodiments. However, those skilled in the art and informed by the teachings herein will realize that the invention is also applicable to various other technical areas or embodiments.

Various embodiments improve management of data center resources such that reachability of virtual machines, virtual appliances or virtual or nonvirtual elements necessary to support virtual entities may be confirmed. Various embodiments retrieve state information associated with virtual machines and necessary supporting elements, which may be correlated with alarms/warnings to determine whether the alarms/warnings are consistent with state information and therefore require no further processing.

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Data Center (DC) architecture generally consists of a large number of computing and storage resources that are interconnected through a scalable Layer-2 or Layer-3 infrastructure. In addition to this networking infrastructure running on hardware devices, the DC network includes software networking components (v-switches) running on general purpose computers, and dedicated hardware appliances that supply specific network services such as load balancers, ADCs, firewalls, IPS/IDS systems etc. The DC infrastructure can be owned by an Enterprise or by a service provider (referred as Cloud Service Provider or CSP), and shared by a number of tenants. Computing and storage infrastructure are virtualized in order to allow different tenants to share the same resources. Each tenant can dynamically add/remove resources from the global pool to/from its individual service.

Virtualized services as discussed herein generally describe any type of virtualized computing or storage resources capable of being provided to a tenant. Moreover, virtualized services also include access to non-virtual appliances or other devices using virtualized computing/storage resources, data center network infrastructure and so on. The various embodiments are adapted to improve event-related processing within the context of data centers, networks and the like.

Generally speaking, the various embodiments enable, support or improve the provisioning and monitoring associated with building a virtual infrastructure layer (e.g., virtual machines, virtual switches, virtual L2/L3 services and the like) on top of a provisioned transport layer within a data center including various network entities/resources. Various embodiments may be extended to include other network elements/resources outside of the data center.

Virtualized services as discussed herein generally describe any type of virtualized computing or storage resources capable of being provided to a tenant. Moreover, virtualized services also include access to non-virtual appliances or other devices using virtualized computing/storage resources, data center network infrastructure and so on. The various embodiments are adapted to improve event-related processing within the context of data centers, networks and the like. The various embodiments advantageously improve such processing even as problems due to the nature of virtual machines, mixed virtual and real provisioning of VMs and the like make such processing more complex. Moreover, as data center sizes scale up the resources necessary to perform such correlation may become enormous and the process may not be handled in an efficient manner. Various embodiments advantageously provide improved efficiency and management of various manageable entities, within a data center, such as real and virtual network elements, links, protocols, computation resources, memory resources, services, objects and the like. In particular, transport layer infrastructure is correlated to specific services delivered thereby, including instantiated virtual machines, VM-enabled appliances, virtual switches, virtual routing/signaling protocols, virtual services and so on within the context of the data center.

By correlating these manageable entities with each other, the impact of a failure of one particular entity upon other entities correlated to the failed entity may be determined more quickly. Similarly, the root cause or related problem leading to the failed entity may also be determined more quickly. Thus, by correlating the services in a real-time manner, the problem space associated with diagnosing poor service performance, infrastructure performance and the like is reduced. For example, if a particular traffic flow, subscriber stream, mobile service and the like fails, then the cause of that failure will be one of the infrastructure components supporting the failed flow, stream, service and the like. Similarly, if an infrastructure component fails, then any flows, streams, services and the like will also fail.

Various embodiments contemplate an extension of the Alcatel-Lucent Service Aware Manager (SAM) product, which provides correlation of mobile services and the like with underlying transport layer infrastructure. Existing SAM functionality discovers the L2/L3 services and various hardware components within transport layer infrastructure, not the virtual components and interconnections. Thus, while the SAM knows that specific L2 and L3 services exist, the SAM is unable to determine which L2 services are associated with which L3 services. Moreover, the SAM is also unable to associate virtual machines with L2 services and, therefore, with L3 services.

Various embodiments contemplate adapting a SAM functionality for use within the context of a data center (DC) to additionally correlate level II and level Ill services to virtual machines (VMs) and the like running on a hypervisor or other platform within the DC. Such correlation includes, illustratively, correlation between various alarms, services, statistics and associated signaling. Thus, various embodiments contemplate an extension of SAM capabilities into the virtual machine space and associated data center environments.

Various embodiments contemplate that processing modules/engines or databases included within SAM are augmented by a VM/service navigation engine which maps or correlates virtual entities to physical entities.

Various embodiments provide mechanisms to achieve L2/L3 correlation.

Various embodiments provide a VM/service navigation engine suitable for use by system owners/operators.

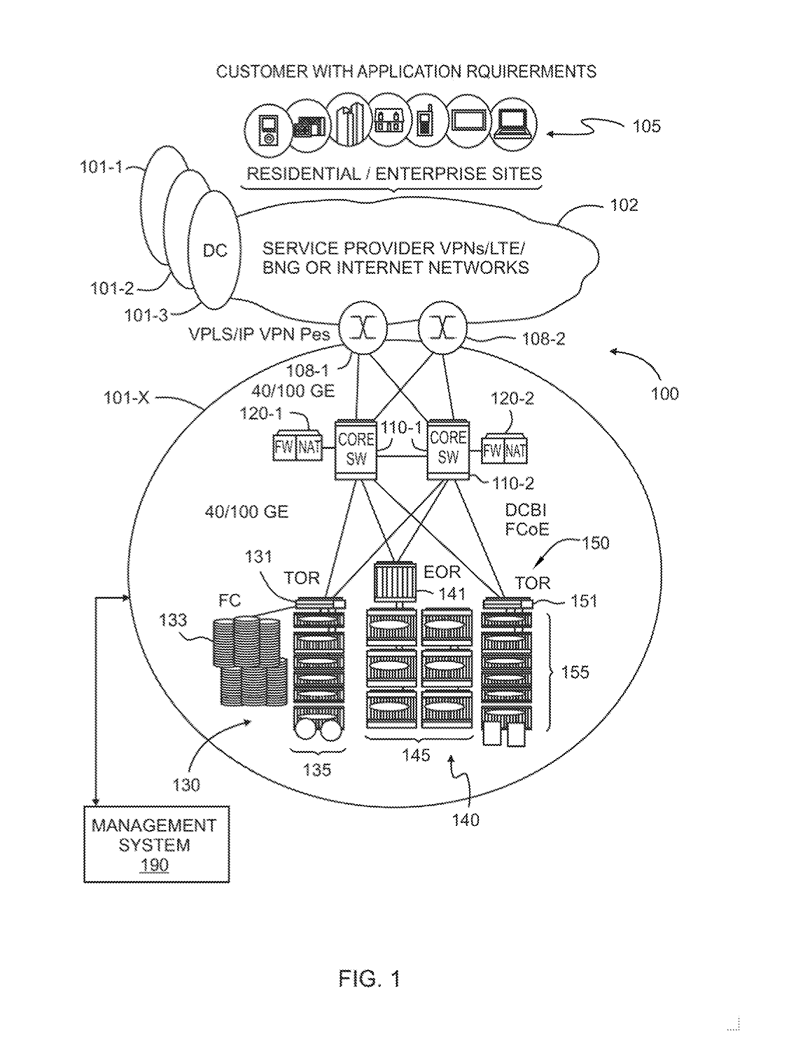

FIG. 1 depicts a high-level block diagram of a system benefiting from various embodiments. Specifically, FIG. 1 depicts a system 100 comprising a plurality of data centers (DC) 101-1 through 101-X (collectively data centers 101) operative to provide computing and storage resources to numerous customers having application requirements at residential or enterprise sites 105 via one or more networks 102.

The customers having application requirements at residential or enterprise sites 105 interact with the network 102 via any standard wireless or wireline access networks to enable local client devices (e.g., computers, mobile devices, set-top boxes (STBs), storage area network components, Customer Edge (CE) routers, access points and the like) to access virtualized computing and storage resources at one or more of the data centers 101.

The networks 102 may comprise any of a plurality of available access network or core network topologies and protocols, alone or in any combination, such as Virtual Private Networks (VPNs), Long Term Evolution (LTE), Border Network Gateway (BNG), Internet networks and the like.

The various embodiments will generally be described within the context of IP networks enabling communication between provider edge (PE) nodes 108. Each of the PE nodes 108 may support multiple data centers 101. That is, the two PE nodes 108-1 and 108-2 depicted in FIG. 1 as communicating between networks 102 and DC 101-X may also be used to support a plurality of other data centers 101.

The data center 101 (illustratively DC 101-X) is depicted as comprising a plurality of core switches 110, a plurality of service appliances 120, a first resource cluster 130, a second resource cluster 140, and a third resource cluster 150.

Each of, illustratively, two PE nodes 108-1 and 108-2 is connected to each of the, illustratively, two core switches 110-1 and 110-2. More or fewer PE nodes 108 or core switches 110 may be used; redundant or backup capability is typically desired. The PE routers 108 interconnect the DC 101 with the networks 102 and, thereby, other DCs 101 and end-users 105. The DC 101 is generally organized in cells, where each cell can support thousands of servers and virtual machines.

Each of the core switches 110-1 and 110-2 is associated with a respective (optional) service appliance 120-1 and 120-2. The service appliances 120 are used to provide higher layer networking functions such as providing firewalls, performing load balancing tasks and so on.

The resource clusters 130-150 are depicted as computing or storage resources organized as racks of servers implemented either by multi-server blade chassis or individual servers. Each rack holds a number of servers (depending on the architecture), and each server can support a number of processors. A set of network connections connect the servers with either a Top-of-Rack (ToR) or End-of-Rack (EoR) switch. While only three resource clusters 130-150 are shown herein, hundreds or thousands of resource clusters may be used. Moreover, the configuration of the depicted resource clusters is for illustrative purposes only; many more and varied resource cluster configurations are known to those skilled in the art. In addition, specific (i.e., non-clustered) resources may also be used to provide computing or storage resources within the context of DC 101.

Exemplary resource cluster 130 is depicted as including a ToR switch 131 in communication with a mass storage device(s) or storage area network (SAN) 133, as well as a plurality of server blades 135 adapted to support, illustratively, virtual machines (VMs). Exemplary resource cluster 140 is depicted as including an EoR switch 141 in communication with a plurality of discrete servers 145. Exemplary resource cluster 150 is depicted as including a ToR switch 151 in communication with a plurality of virtual switches 155 adapted to support, illustratively, the VM-based appliances.

In various embodiments, the ToR/EoR switches are connected directly to the PE routers 108. In various embodiments, the core or aggregation switches 120 are used to connect the ToR/EoR switches to the PE routers 108. In various embodiments, the core or aggregation switches 120 are used to interconnect the ToR/EoR switches. In various embodiments, direct connections may be made between some or all of the ToR/EoR switches.

A VirtualSwitch Control Module (VCM) running in the ToR switch gathers connectivity, routing, reachability and other control plane information from other routers and network elements inside and outside the DC. The VCM may run also on a VM located in a regular server. The VCM then programs each of the virtual switches with the specific routing information relevant to the virtual machines (VMs) associated with that virtual switch. This programming may be performed by updating L2 or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR switch performs just tunnel forwarding without being aware of the service addressing.

Generally speaking, the “end-users/customer edge equivalents” for the internal DC network comprise either VM or server blade hosts, service appliances or storage areas. Similarly, the data center gateway devices (e.g., PE servers 108) offer connectivity to the outside world; namely, Internet, VPNs (IP VPNs/VPLS/VPWS), other DC locations, Enterprise private network or (residential) subscriber deployments (BNG, Wireless (LTE etc), Cable) and so on.

In addition to the various elements and functions described above, the system 100 of FIG. 1 further includes a Management System (MS) 190. The MS 190 is adapted to support various management functions associated with the data center or, more generically, telecommunication network or computer network resources. The MS 190 is adapted to communicate with various portions of the system 100, such as one or more of the data centers 101. The MS 190 may also be adapted to communicate with other operations support systems (e.g., Element Management Systems (EMSs), Topology Management Systems (TMSs), and the like, as well as various combinations thereof).

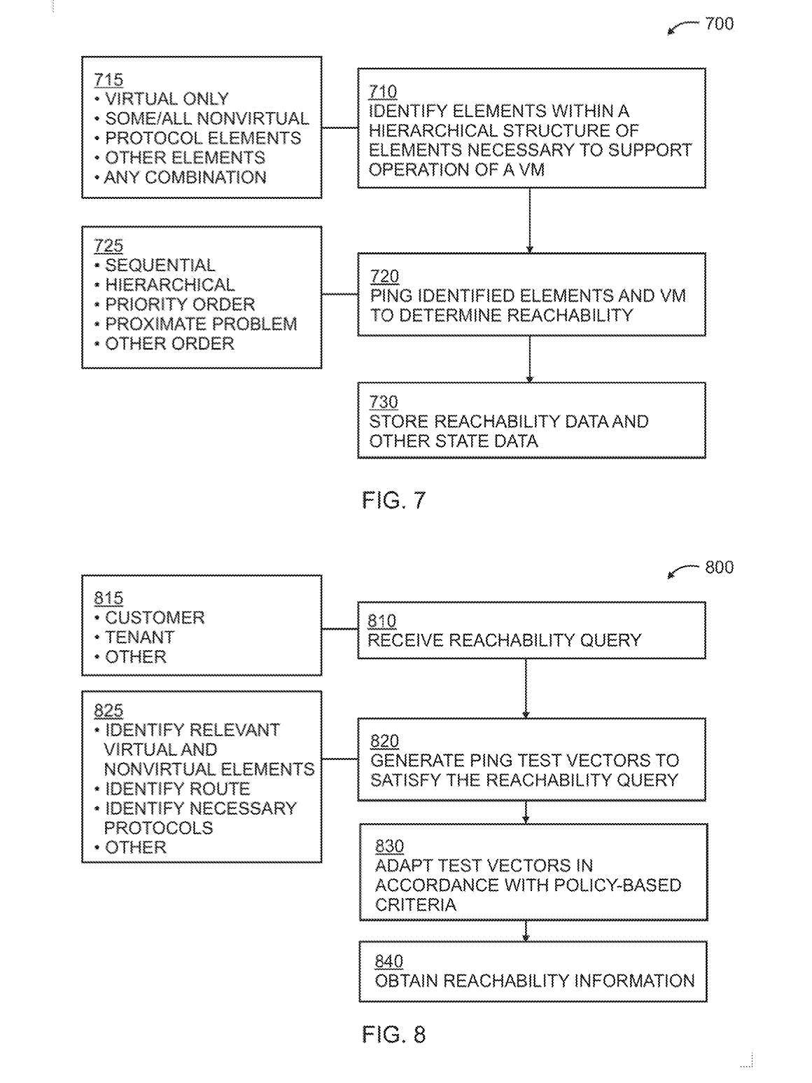

The MS 190 may be implemented at a network node, network operations center (NOC) or any other location capable of communication with the relevant portion of the system 100, such as a specific data center 101 and various elements related thereto. The MS 190 may be implemented as a general purpose computing device or specific purpose computing device, such as described below with respect to FIG. 7.

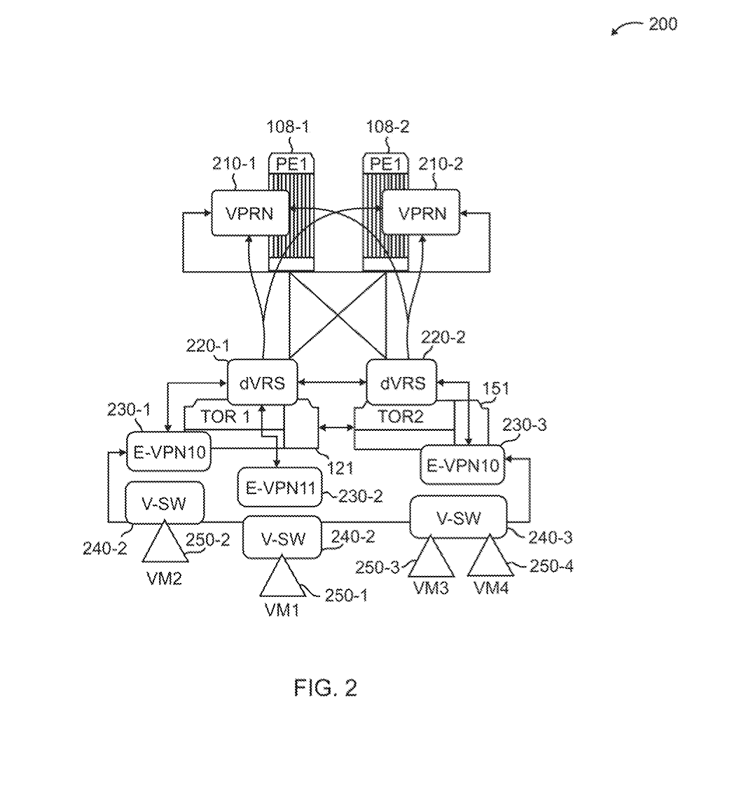

FIG. 2 depicts a simplified view of the system of FIG. 1 useful in understanding the present embodiments.

Referring to FIG. 2, the simplified view 200 depicts a pair of provider edge (PE) nodes 108, where each of the PE nodes 108 communicates with each other as well as each of a pair of Top-of-Rack (ToR) switches 131 and 151 via a layer 3 service such as Virtual Private Routed Network (VPRN), Virtual Routing and Switching (VRS), Internet Enhanced Service (IES) and the like.

Layer 3 (L3) services supporting communications between and among PE 108-1, PE 108-2, ToR 131 and ToR 151 are depicted as being implemented by establishing Virtual Private Routed Network (VPRN) services 210 at each of the PE nodes 108, and dVRS services at each of the ToR switches 131/151. Thus, the L3 services are supported by the PE nodes 108, ToR switches 131/151 and various other real or virtual entities there between. It should be noted that while a particular layer 3 services depicted, other layer 3 services may also be used in various embodiments.

Each of the ToR switches 131/151 support with one or more virtual switches and one or more virtual machines. For example, ToR 131 is depicted as supporting first 240-1 and second 240-to instantiated virtual switches (V-SWs), while ToR 151 is depicted as supporting a third 240-3 virtual switch. Further, first virtual switch 240-1 communicates with a first virtual machine (VM) 250-1, second virtual switch 250-2 communicates with a second VM 250-2, while third virtual switch 250-3 communicates with each of a third VM 250-3 and fourth VM 250-4.

Layer 2 (L2) services supporting communications between and among the virtual switches 240 and VMs 250 are implemented by establishing a E-VPN 230 between ToRs 131 and 151 such that virtual switching, traffic propagation and the like may be provided between the various virtual elements. In essence, the transport/switching infrastructure provided by the ToRs 131/151 is used to support the virtualized communication paths between the various virtual switches 240 and virtual machines 250.

Various embodiments implement a correlation and navigation function adapted to fully correlate virtual machines, virtual switches or other virtual entities to L2 and other services, and fully correlate L2/L3 services associated with a common tenant, customer and the like.

Exemplary data center architectures or portions thereof, such as described herein with respect to FIG. 1 and FIG. 2, benefit from the various embodiments. For example, an Alcatel-Lucent Copperback router/switch may be used in client networks such as data centers, where the data center may comprise hundreds or thousands of server racks, and where each rack includes a number of servers (e.g., blades) used to create and render virtual machines.

In the exemplary architectures discussed above, the TOR switches or EOR switches at each rack manage the servers of that rack and communicates with the management system 190, illustratively a management system including service where Alcatel-Lucent Service Aware Manager (SAM) functionality. The management system manages the TOR/EOR routers/switches and the VMs instantiated within the servers. The TOR/EOR switch also operates the various services such as the Layer 3 services (e.g., VPRN) and Layer 2 services (e.g., VPLS).

Each server typically includes a respective instantiation of Hypervisor software for managing the various VMs of that server. The Hypervisor provides management of VMs and their services for multiple customers (e.g., tenants) in a secure manner, according to various policies that define operating parameters conforming to the relevant SLAs. A session established between a hypervisor and corresponding TOR/EOR, such as an OpenFlow session, is used to enable appropriate instantiation and management of the various virtual machines and virtual switches.

The instantiated VMs may be correlated their physical ports on the TOR. In an exemplary topology, once a VM is provisioned, a virtual port is created. The virtual port is associated with or attached to a layer 2 (VPLS) service, which is also denoted herein as an eVPN service. Each layer 2 (VPLS) service is associated with or attached to a layer 3 (VPRN) service, which in turn may be attached to other VPRN services. For example, assume that multiple VMs are instantiated at different servers, where each server is associated with a respective top of rack (TOR) router. Thus, at a first site (e.g., server 1), one or more virtual machines are associated with a layer 2/VPLS service. Similarly, at a second site, one or more virtual machines are associated with the same layer 2/VPLS service network, such as depicted above with respect to FIG. 2.

Data is transmitted from the VMs to provider equipment (PE) edge routers such as Alcatel-Lucent 7750 service routers via the L2NPLS service network, to the L3/VPRN.

In various embodiments, multiple VPLS sites and multiple VPRN sites are used. A discovery process enables discovery of each of at least a plurality of the TORs/EORs such that a database may be constructed to include VPLS, VPRS, sites, VMs etc. of the TOR(s). This database is used to derive the various correlations among the virtual and non-virtual entities.

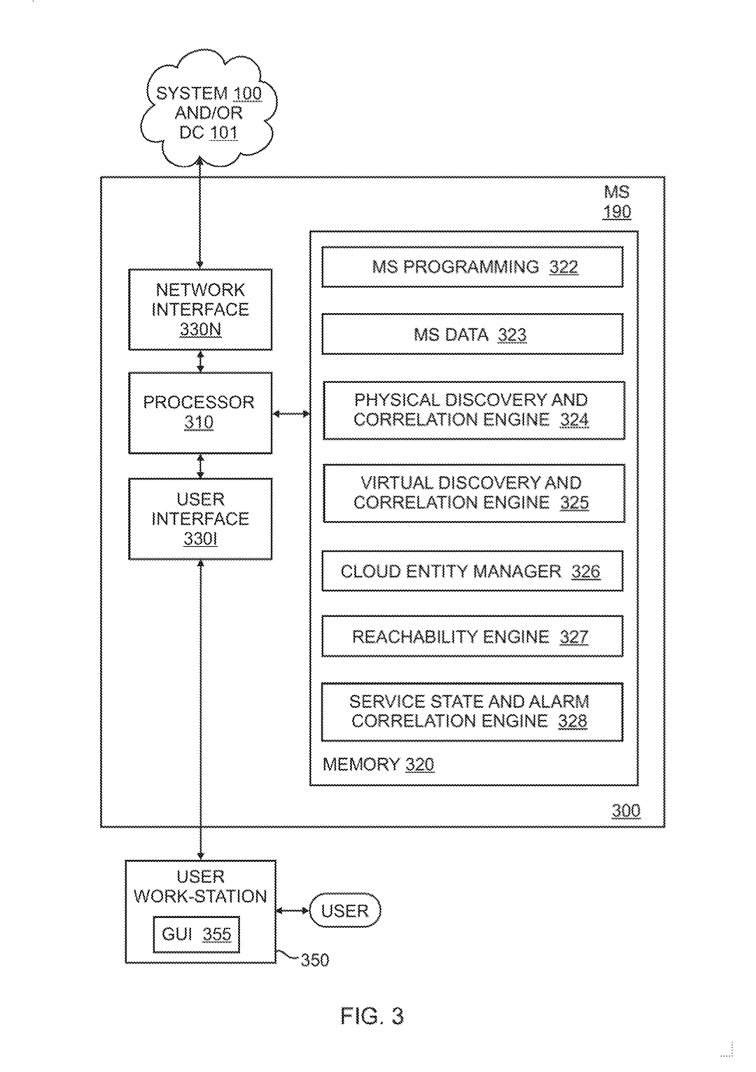

FIG. 3 depicts an exemplary management system suitable for use as the management system of FIG. 1. As depicted in FIG. 3, MS 190 includes one or more processor(s) 310, a memory 320, a network interface 330N, and a user interface 3301. The processor(s) 310 is coupled to each of the memory 320, the network interface 330N, and the user interface 3301.

The processor(s) 310 is adapted to cooperate with the memory 320, the network interface 330N, the user interface 3301, and the support circuits 340 to provide various management functions for a data center 101 or the system 100 of FIG. 1.

The memory 320, generally speaking, stores programs, data, tools and the like that are adapted for use in providing various management functions for the data center 101 or the system 100 of FIGS. 1 and 2.

The memory 320 includes various management system (MS) programming modules 322 and MS databases 323 adapted to implement network management functionality such as discovering and maintaining network topology, correlating various elements and sub-elements, monitoring/processing virtual elements related requests (e.g., instantiating, destroying, migrating and so on) and the like.

The memory 320 includes a physical discovery and correlation engine (PDCE) rules engine 324 operable to retrieve, generate and otherwise process configuration information, status information and connection information associated with various physical (i.e., nonvirtual) resources within the data center, and to correlate these physical resources with each other and with the L2/L3 services as well as other services they support. While depicted as a separate entity, the PDCE 324 may be implemented within the context of the MS programming 332 or other functional element/engine described herein.

The memory 320 includes a virtual discovery and correlation engine (VDCE) 325 operable to retrieve, generate and otherwise process configuration information, status information and connection information associated with various virtual resources instantiated/deployed within the data center, and to correlate these virtual resources with each other, with the L2/L3 services as well as other services they support, and with the physical resources necessary to support the virtual resources. While depicted as a separate entity, the VDCE 325 may be implemented within the context of the MS programming 332 or other functional element/engine described herein.

In various embodiments, the memory 320 includes a Cloud Entity Manager (CEM) 326 providing alarm management, policy distribution, auditing and other functions. The CEM itself may be treated as an object by a higher level management entity. While depicted as a separate entity, the CEM 326 may be implemented within the context of the MS programming 332 or other functional element/engine described herein.

In various embodiments, the memory 320 includes a reachability engine (RE) 327 operable to communicate with (i.e., “reach”) various virtual entities (optionally, nonvirtual entities) as well as necessary/supporting virtual/nonvirtual entities to determine whether a particular entity such as a virtual machine is operable or communicative. While depicted as a separate entity, the RE 327 may be implemented within the context of the MS programming 332 or other functional element/engine described herein.

In various embodiments, the memory 320 includes a service state and alarm correlation engine (SSACE) 328 operable to maintain virtual elements/entity (optionally, nonvirtual element/entity) service state information and correlate/update this information in response to received alarms or historical alarm information. While depicted as a separate entity, the SSACE 328 may be implemented within the context of the MS programming 332 or other functional element/engine described herein.

Generally speaking, the virtual and physical resources comprise various hierarchically related network elements, network sub elements, communications links, communication channels, logical objects, entities, protocols and the like which, upon failure, necessarily cause the failure of corresponding hierarchically lower level objects, entities, protocols and the like.

In various embodiments, the MS programming module 332, physical discovery and correlation engine 324, virtual discovery and correlation engine 325, cloud entity manager 326, reachability engine 327 or service state and alarm correlation engine 328 are implemented using software instructions which may be executed by a processor (e.g., processor(s) 310) within one or more management or network elements for performing the various management functions depicted and described herein.

The network interface 330N is adapted to facilitate communications with various network elements, nodes and other entities within the system 100, DC 101 or other network to support the management functions performed by MS 190.

The user interface 3301 is adapted to facilitate communications with one or more user workstations (illustratively, user workstation 350), for enabling one or more users to perform management functions for the system 100, DC 101 or other network.

As described herein, memory 320 includes the MS programming module 322, MS databases 323, PDCE 324, VDCE 325, CEM 326, RE 327 and SSACE 328, which cooperate to provide the various functions depicted and described herein. Although primarily depicted and described herein with respect to specific functions being performed by rousing specific ones of the engines or databases of memory 320, it will be appreciated that any of the management functions depicted and described herein may be performed by rousing any one or more of the engines or databases of memory 320.

The MS programming 322 adapts the operation of the MS 140 to manage various network elements, DC elements and the like such as described above with respect to FIGS. 1-2, as well as various other network elements (not shown) or various communication links therebetween. The MS databases 323 are used to store topology data, network element data, service related data, VM related data, protocol related data and any other data related to the operation of the Management System 190. The MS program 322 may implement various service aware manager (SAM) or network manager functions.

Each virtual and nonvirtual object/element/entity generating events communicate these events to the MS 190 or other object/element/entity via respective event streams. The MS 190 processes the event streams as described herein and, additionally, maintains an event log associated with each of the individual event stream sources. In various embodiments, combined event logs are maintained.

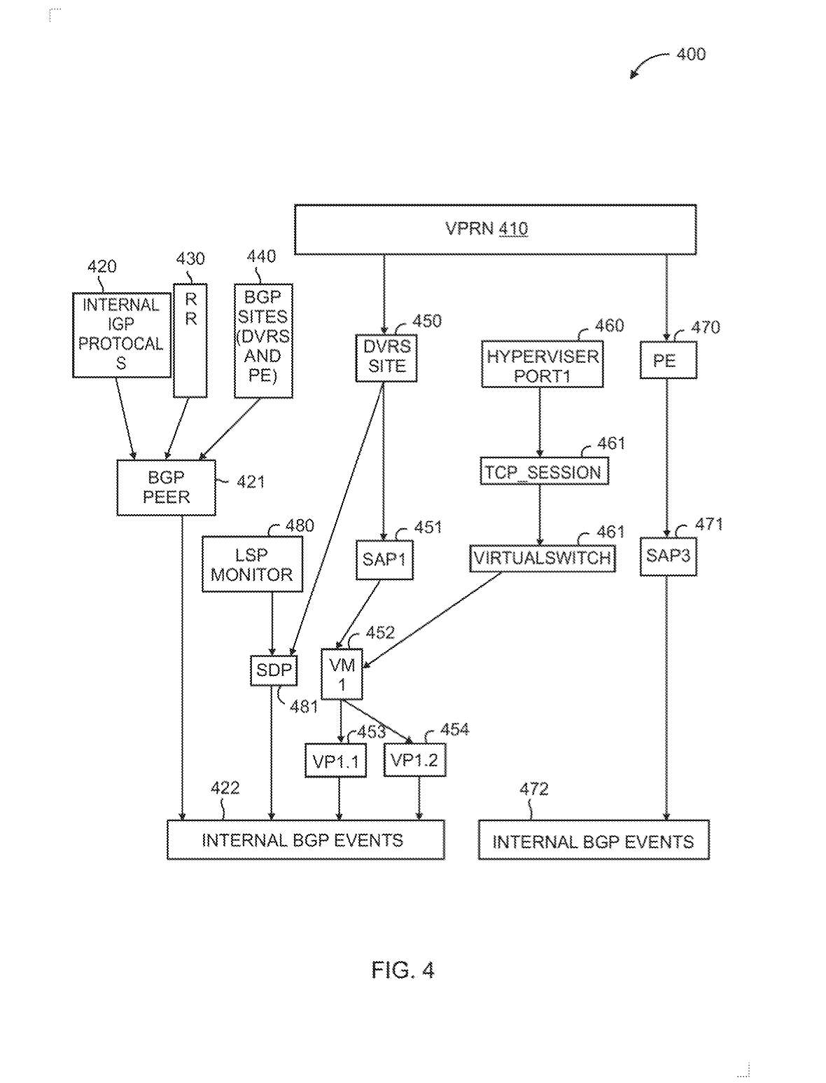

FIG. 4 graphically depicts hierarchy of relationships of DC entities supporting an exemplary virtualized service useful in understanding the embodiments. Specifically, FIG. 4 depicts virtual and nonvirtual DC objects/entities supporting a Virtual Private Routed Network (VPRN) service as well as the parent/child failure relationships between the various DC objects/entities.

Referring to FIG. 4, it can be seen that a top level VPRN service 410 is a higher-level object with respect to a DVRS site 450 and a provider edge (PE) router 470. PE router 470 is a higher-level object with respect to SAP2 471, which is a higher-level object with respect to external BGP unreachable events 472. DVRS site 450 is a higher-level object with respect to SAP1 451 and SDP 481, which is a higher-level object with respect to internal BGP unreachable events 422. Label Switched Path (LSP) monitor 480 is also a higher-level object with respect to Service Distribution Path (SDP) 481.

SAP1 451 is a higher-level object with respect to a first virtual machine (VM 1) 452, which is a higher-level object with respect to first virtual port (VP1.1) 453 and second virtual port (VP1.2) 454 of the first the end 452. Each of the first 453 and second 454 virtual ports are higher-level objects with respect to internal BGP unreachable events 422.

Internal Gateway Protocols (IGPs) 420, Route Reflectors (RR) 430 and Border Gateway Protocol (BGP) sites (e.g., DVRS and PE) 440 are all higher-level objects with respect to a BGP peer 421, which is a higher-level object with respect to internal BGP unreachable events 422.

A first hypervisor port 460 is a higher-level object with respect to a TCP session 461, which is a higher-level object with respect to a virtual switch 462, which is a higher-level object with respect to first VM 452.

Thus, FIG. 4 depicts the various parent/child failure relationships among a number of DC objects/entities forming an exemplary VPRN service 410. The failure of any object/element/entity representing a higher-level or parent object/element/entity in a failure relationship with one or more corresponding lower level or child objects/entities will necessarily result in the failure of the lower-level or child objects/entities. Further, it can be seen that multiple levels or tiers within a hierarchy of failure relationships are provided. Further, it can be seen that an object/element/entity may have failure relationships with one or more corresponding higher-level or parent objects/entities, one or more lower-level or child objects/entities or any combination thereof.

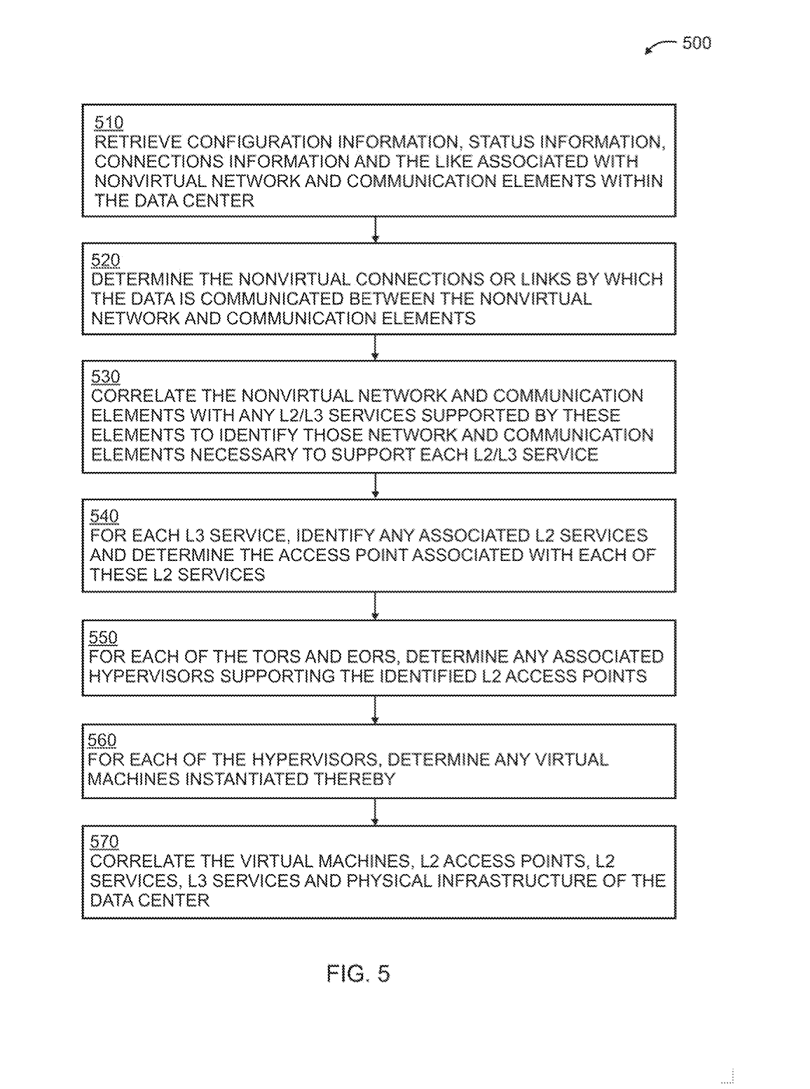

FIG. 5 depicts a flow diagram of a method according to one embodiment. Specifically, FIG. 5 depicts a flow diagram of a method 500 providing physical element discovery and correlation functions within the context of a data center.

At step 510, configuration information, status information, connections information and so on associated with the physical (i.e., nonvirtual) network elements and communications elements within the data center are retrieved from the various elements, management entities and the like within or external to the data center. This information may be stored in a physical discovery and correlation database or some other memory element, such as within the MS data 323 of the memory 320.

At step 520, a determination is made as to the nonvirtual connections or links by which data is communicated between the various nonvirtual network and communication elements. For example, specific network element connections may be determined by routing test packets through the system, injecting test vectors and the like. This information may be stored in a physical discovery and correlation database or some other memory element, such as within the MS data 323 of the memory 320.

At step 530, the nonvirtual network and communication elements are correlated with any L2/L3 services supported by these elements to identify those network and communication elements necessary to support each of these L2 or L3 services. This information may be stored in a physical discovery and correlation database or some other memory element, such as within the MS data 323 of the memory 320. That is, the nonvirtual network elements, communications elements and the like that are necessary to support each of a plurality of nonvirtual L2/L3 services (virtual L2/L3 services if known) are correlated to such services.

Thus, steps 510-530 operate to discover the L2/L3 services and various hardware components within the physical infrastructure of the data center, though not necessarily the virtual components and interconnections. That is, while these operations generate information pertaining to existing L2 and L3 services, the operations may not be able to determine which L2 services are associated with which L3 services. Moreover, the operations may not be able to determine which virtual machines are associated with which L2 services and, therefore, associated with which L3 services.

At step 540, for each L3 service, any associated L2 services are identified, and the access points associated with each of these L2 services is determined. This information may be stored in a physical discovery and correlation database or some other memory element, such as within the MS data 323 of the memory 320.

At step 550, for each of the ToRs/EoRs, any associated hypervisors supporting the access point to the identified L2 services are determined. This information may be stored in a physical discovery and correlation database or some other memory element, such as within the MS data 323 of the memory 320.

At step 560, for each of the hypervisors, any virtual machines instantiated thereby are determined. This information may be stored in a physical discovery and correlation database or some other memory element, such as within the MS data 323 of the memory 320.

At step 570, a correlation is made between the virtual machines, L2 access points, L2 services, L3 services and physical infrastructure of the data center to identify thereby which specific entities/elements are necessary to support which other specific entities/elements in the data center.

By correlating some or all of these entities/elements a determination may be made as to which entities/elements are impacted by the failure of one object/element/entity, as well as which other entities/elements might have caused the failure of the object/element/entity.

Various embodiments described herein provide a management functionality wherein some or all of the various correlations are provided to internal or external management entities. In this manner, a network manager or related entity may accurately identify the physical port used by each VM as well as the specific L2/L3 services used by each of the VMs.

Various embodiments contemplate a graphical user interface (GUI) functionality suitable for use at a Network Operations Center (NOC). For example, a user may select a specific customer VPRN service via the GUI to effect retrieval of a GUI screen showing the specific VMs associated with the VPRN services of that customer. Similarly, from an L3 service selection screen, a list of transported services may be obtained and selected to derive details of the various VMs and the like for troubleshooting purposes. For example, in the case of a failure to reach a particular VM, a problem may be suspect with respect to a hierarchically relevant edge router, hypervisor, L2 service, L3 service and so on.

Various embodiments contemplate methods/mechanisms to manually or automatically enable navigation, correlation and the like, such as within the context of a NOC. Various embodiments contemplate methods/mechanisms specifically adapted to the NOC environment, as well as capabilities extended for use by network operators, customers, tenants, sub-tenants and so on.

Various embodiments contemplate methods/mechanisms enabling migration of VMs, trigger events associated with such migrations and so on. For example, such trigger event may be defined by QoS threshold levels, by SLA or other agreement, by deficiencies in one or more monitored performance criteria or other parameters.

Generally speaking, various embodiments provide mechanisms to monitor virtual machines, VM-based appliances and the like in anticipation of failures or service degradations, or for general load balancing/performance improvements. As an example, given a MAC ping failure (i.e., an inability to reach a VM), the question becomes whether the VM itself is gone down or whether one of the perhaps hundreds of L2 services supporting the VM has failed or degraded to the point of causing the MAC ping failure.

Various embodiments contemplate processes for auditing existing performance or connections associated with virtualized elements such as according to SLA requirements or other criteria; perhaps performing migrations in response to auditing results.

Various embodiments contemplate using Service Level Agreements (SLAs) to define service levels of VMs instantiated by the manager, wherein the manager may periodically audit instantiated VMs to ensure that contracted for service levels are maintained. Again, the manager may migrate VMs or other virtualized services as necessary in response to deficiencies identified by audit, customer feedback, alarm other source. Background processing models, background auditing, background alarm/error response behavior and the like are also contemplated.

Various embodiments discussed herein are applicable within the context of rapid diagnosis and remediation of various routing/switching problems (e.g., problem with MAC ping, IP ping etc.), which find particular utility within the context of large data centers and the like with hundreds or thousands of L2/L3 services.

The VMs may be implemented in any software environment (Windows, LINUX etc.). The VMs provide alarm indications to the manager. The VMs may also respond to API hooks and the like to report problems. Each VM is associated with a UU identifier and an IP address. A UUID is a unique identifier for a VM across the entire address space. The UUID or IP address of a VM may be mapped to a particular TOR, TOR port, Hypervisor, L2 service, L3 service and the like. Multiple VMs can be using the same connections, virtual port etc., source that a specific VM associate with a problem may be readily identified.

The above-described use cases generally contemplate using correlation information to identify hierarchically lower level entities/elements associated with a hierarchically higher level object/element/entity.

Various other embodiments are directed to use cases in which correlation information is used to identify hierarchically higher level entities/elements associated with a hierarchically lower level object/element/entity.

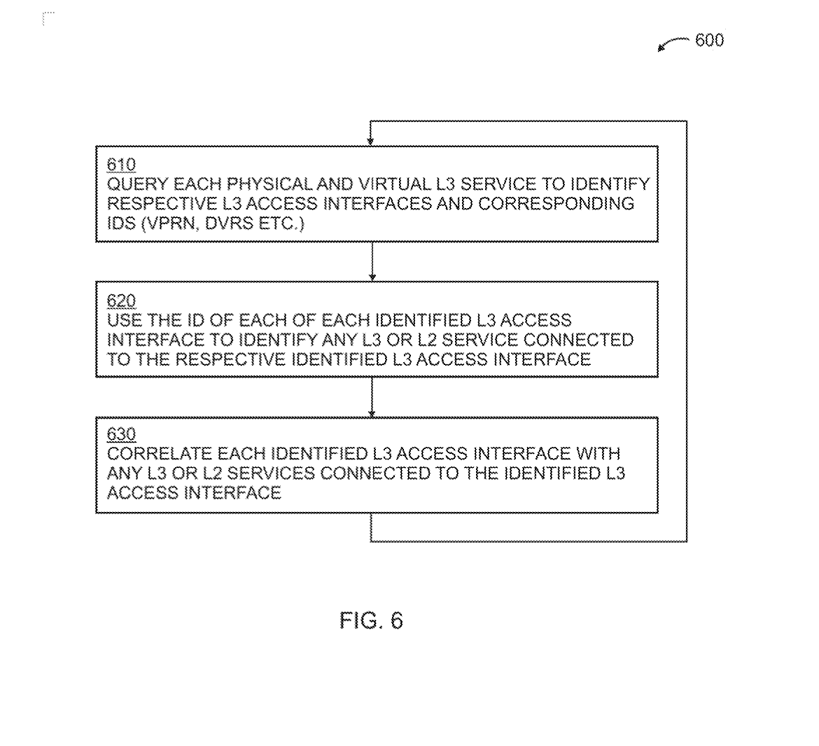

FIG. 6 depicts a flow diagram of a method according to one embodiment. Specifically, FIG. 6 depicts a trace back method suitable for use in correlating virtual services to other virtual services as well as nonvirtual services. While the method 600 will be described within the context of specific services (e.g., VPRN, dVRS, VPLS and eVPN services), the method is equally applicable to other virtual and nonvirtual services. In particular, the method 600 will be described

At step 610, existing L3 services such as VPRN, dVRS and the like are repeatedly queried to identify their respective L3 access interfaces, such as via the VPLS ID or dVRS ID that is associated with each L3 access interface of these L3 services.

At step 620, the ID of each of each identified L3 access interface is used to identify any L3 or L2 service connected to the respective identified L3 access interface. For example, L3 or L2 services connected to an access interface of an L3 service will have provisioning information including the access interface ID associated with the L3 service to which they are connected.

At step 630, a correlation is made between each identified L3 access interface and any L3 or L2 services connected to the identified L3 access interface.

For example, referring to FIG. 2, the L2 services 230 denoted as E-VPN10 and E-VPN11 will be correlated to the L3 service 220 denoted as dVRS. Similarly, the L3 service 220 denoted as dVRS will be correlated to the L3 service 210 denoted as VPRN.

Steps 610-630 of the method 600 are continually repeated to provide thereby a substantially up to date correlation of L2/L3 services within the context of a data center.

The various embodiments described herein contemplate DC service manager function in which virtual and nonvirtual services may be isolated from each other from a management perspective. In these embodiments, the various functions described above with respect to the figures are modified such that the discovery functions return information indicative of whether or not a particular DC element, sub element, object, entity and the like is a virtual entity or a nonvirtual entity.

For those entities that are nonvirtual or physical in nature, standard management techniques may be employed to process configuration updates, session modifications, alarm streams and the like. In this manner, various processing techniques normally associated with the virtual DC elements may be avoided or modified to conserve resources.

For those entities that are virtual in nature, management techniques specifically directed to processing such virtual entities may be employed.

For example, in various embodiments the data center will not connect virtual machines to a regular (i.e., nonvirtual) service such as VPRN (e.g., VPRN 210 of FIG. 2) or any other kind of VPLS. Instead, only virtual services such as dVPRN and dVPRS will be used to support virtual machines. Further, various embodiments contemplate that these various services and divisions thereof are implemented on TOR or EOR elements within the data center.

Various embodiments contemplate parallel management processing functions; namely, nonvirtual element management functions operating in parallel with the virtual element processing functions. Thus, in various embodiments, the MS programming 332 contemplates that management functions are implemented for physical or nonvirtual entities using the PDCE 324, while management functions are implemented for virtual entities using the VDCE 325.

By separating management associated with the virtual and nonvirtual entities, data center specific L2/L3 tunnels may be established/recognized and efficiently managed. For example, various embodiments contemplate virtual and nonvirtual L3 entities such as dVRS and VPRN. For example, various embodiments contemplate provisioning services in a MA avoiding trembling such as within the context of a DVRS service.

Various embodiments contemplate eVPRS and eVPRN services using a different encapsulation technique. The VPRN in this case is of a type Distributed Virtual Routing and Switching (DVRS). Enhanced virtual private network (EVPN) is provided in some embodiments using dVXLAN.

As an example, consider the case of a data center having provisioned therein a plurality of virtual machines instantiated by third parties on behalf of their respective tenants. In response to a tenant need for additional space, one or more virtual machines are created for the tenant, where each of the VMs may be associated with VPLS services, VPRN services, memory allocations, QoS constraints and so on. In the event of the tenant experiencing some problem, the correlation of the various virtual and nonvirtual services provides a mechanism by which rapid response to the problem may be provided to that tenant by either the third-party or by the data center management system itself.

Further, migrating virtual machines, switches, services and the like associated with one or more tenants may be more efficiently performed where all of the various entities are correlated such that the choral instruction may be replicated quickly by the migration function. The various management functions contemplate managing one or more ToR/EoR entities such that the specifics of migration, trace back, alarm processing, auditing, discovery or other functions may be efficiently handled by a central processing entity.

Data centers may be rapidly implemented via modular data center equipment provided by several vendors. For example, Hewlett-Packard provides data center “pods,” wherein each pod comprises a shipping container full of racks and servers and a power connection which, when plugged in and connected to a network, provide or augment data center resources.

Various embodiments contemplate a method for implementing service assurance associated with single or multiple data centers or portions thereof using a Cloud Entity Manager (CEM) providing alarm correlation, policy distribution, auditing and other functions associated with a defined data center or portion thereof. The CEM may be treated as an object by a higher-level service aware manager. The CEM may be implemented within the context of management system 190 as noted above with respect to FIG. 3.

For example, each pod may be associated with a respective CEM for managing the alarm correlation, policy distribution, auditing and other functions associated with the respective pod. That is, a CEM performing various service aware management functions may represent its particular pod or data center portion as a specific entity wherein all real and virtual objects, elements, services and so on associated with the pod are correlated to the specific CEM entity. A centralized management entity implementing various service aware management functions may perform various service assurance functions associated with each pod using the respective CEM entity associated with the pod.

Thus, the data center may comprise a plurality of pod elements, where each of the pod elements includes a plurality of ToR/EoR elements, L3 services, L2 services, computing resources, storage resources, virtual switches, virtual machines, virtual appliances, virtual ports and so on. All of these elements are logically represented within the context of the CEM, SAM or other management functions deployed to support data center operations.

It is noted that management of pods and similar data center installations provides additional management challenges. While various network automation tools exist to “bring up” the pod to deploy/create the various data center services, tools for subsequent management of pods are insufficient at present. For example, a Cloud Network Administrator (CNA) tool manages the user facing portion of what a service provider, data center operator or tenant is trying to achieve, such as rolling out department VMs and the like. However, this tool does not contemplate a number of management functions deemed to be important in the context of pods or similar modular data center and limitations or upgrades.

Various embodiments contemplate correlation and subsequent management of virtual and nonvirtual elements associated with multiple pods forming a data center. Such management provides virtual/nonvirtual L2/L3 correlation as discussed herein, irrespective of the particular pod or other physical hardware location used to support these services.

For example, if there is a fire in Pod 1 of a particular DC, then there is also a need to begin migrating tenant services over to Pod 2 of the DC. This operation must be performed in a manner retaining service levels (if possible) while timely notifying customers/tenants of its occurrence. In various embodiments, policy information is deployed to every node within pods one and two to enable rapid migration of services therebetween.

In various embodiments, the CEM operates within the context of a hierarchical representation of the real world system, wherein each of the entity and a hierarchical relationship to others is maintained as objects and sub objects within the relational database. The CEM enables rapid response to customer inquiries, such as identify all entities within the hierarchical representation associated with a particular UUID, pod, TOR, service and the like. This problem is complicated given multiple data centers or logically segregated data centers.

Various embodiments also contemplate CEM monitoring of performance data associated with the various virtual and nonvirtual entities to ensure or enforce Service Level Agreement (SLA) criteria.

Thus, various embodiments contemplate a hierarchical representation of a data center or portions thereof wherein virtual and nonvirtual entities are correlated to enable thereby precise management of these entities.

Various embodiments also contemplate bifurcated management of virtual and nonvirtual entities to enable the use of specific management tools suited to the specific type of entity group; namely, tools more suited to managing virtual entities versus tools more suited to managing nonvirtual entities.

Reachability Engine

The reachability engine 327 may be used to verify that routes to VMs are operational such as by sequential querying or pinging each of various entities that ultimately support the VMs, leading up to pinging of the VMs themselves. Peer entities may ping each other. By testing reachability between various entities, the most efficient routes may be determined. Further, reachability and other state information associated with the VMs as well as the various virtual and nonvirtual entities is necessary to support the VMs.

It is noted that the term “ping” as used herein may at times denote a different functionality than that normally associated with a standard IP ping (i.e., transmitting a packet to a network element and receiving a reply packet and return, where the ping parameter of interest is the number of milliseconds associated with this round-trip).

In various embodiments, to ping a particular UUID of a VM, the NIC card of the TOR is accessed to determine the virtual port associated with the appropriate VM. To ping a VM, the TOR port associated with the virtual port of the VM is pinged. Various elements contemplate pinging through multiple layers (virtualized or nonvirtualized), pinging through protocols and so on. Pinging operations optionally also account for TOR and hypervisor delays. A ping from a PE to a virtual port of a VM may be provided. Different types of pinging may be used within the context of the various embodiments.

FIG. 7 depicts a flow diagram of a method according to one embodiment. Specifically, FIG. 7 depicts a flow diagram of a method 700 for obtaining reachability information associated with a virtual machine and various virtual (optionally nonvirtual) elements necessary to support operation of the virtual machine. This reachability information, along with other operating state information pertaining to the VM and supporting elements may be stored in a database for further processing, such as correlation to received alarms and the like to identify problems within a data center.

At step 710, elements within a hierarchical structure of elements necessary to support operation of a virtual machine are identified. For example, the hierarchical elements associated with the operation of any particular virtual machine comprise both instantiated virtual elements as well as nonvirtual elements within the data center necessary for the virtual machine of interest to function. Failure of any of these elements will lead to failure of the virtual machine. Referring to box 715, identified elements may comprise only virtual elements, virtual elements plus some or all of the nonvirtual elements supporting the virtual machine, protocol elements (L2/L3 protocols, BGP, the IPsec tunnels and the like) as well as other elements deemed to be necessary or of particular interest with respect to the operation of the virtual machine of interest. Further, any combination of these elements may be identified for this purpose.

At step 720, the virtual machine of interest as well as each of the identified elements is pinged to determine its reachability. As will be appreciated, while described within the context of an Internet Protocol “ping” function (transmitting a packet to the elements and waiting for a packet to be received in return), any function useful in determining whether or not specific virtual or nonvirtual elements within the data center is functioning may be used. Referring to box 725, the ping or other reachability function is executed in any of a sequential manner (e.g., a sequence of logically or physically adjacent elements/subelements leading to the VM of interest), a hierarchical manner (e.g., a top-down or bottom-up sequence of elements/subelements within a hierarchy of elements/subelements supporting the VM of interest), a priority based order (e.g., a sequence of first priority order elements, followed by second priority elements and so on); proximate problem elements (e.g., a sequence of elements/subelements beginning with those proximate a known problem such as a failed switch, server and the like) or some other order or combination thereof.

At step 730, reachability data and other state data associated with the VM of interest as well as the other identified elements may be stored within a database for further processing. Reachability or state data indicative of an unreachable VM of interest or intervening element may be used to trigger additional mechanisms to identify or recover from a problem within the data center.

In various embodiments, reachability information may be periodically obtained for each of the virtual elements within the data center. In various embodiments, the reachability information is obtained more frequently for virtual elements deemed to be of higher priority, such as virtual elements associated with high priority customers, high-priority tenants, high-security data, particular types of data (e.g., voice, video and the like) and so on. Thus, the reachability method 700 may be performed more frequently for some virtual elements than for other virtual elements.

Reachability information may be obtained periodically such as upon the expiration of a timer (i.e., at the end of each of a sequence of predetermined time intervals). The timer or predetermined intervals associated with different types or classes of virtual elements may be adjusted in response to the various priority criteria.

Reachability information may be obtained in response to an alarm or warning condition, such as a determination that a particular virtual or nonvirtual element is failed or degraded in some way. For example, in response to a warning associated with a switching resource (e.g., a rack) supporting multiple virtual switches, those virtual machines associated with the virtual switches may require migration to a backup switching resource. In this case, specific reachability information associated with those virtual machines most likely to fail first may be obtained to ensure that migration is possible.

Reachability information may be obtained in response to a request from a customer, tenant, service provider or other entity, such as a tenant trying to perform a fault isolation process in which reachability information from the data center is necessary.

Generally speaking, reachability information may be obtained from any data center element, such as a routing device, storage device, computational device, communication device and so on.

In various embodiments, the reachability engine may be selectively used with respect to certain virtual entities to determine whether or not entities are reachable, efficiently reachable, healthy or characterize a ball in some other manner. In these embodiments, entity queries such as pings and the like may provide a response including state information, response packets and the like within a certain period of time. All of this information is relevant in assessing the reachability of an entity, the relative efficiency of the reaching entity, whether or not the entity is healthy, whether or not necessary supporting entities are themselves efficient/healthy and so on.

In various embodiments, routes to virtual machines are themselves verified as described above. Virtual entities, intermediate virtual or nonvirtual entities, routes associated with these various entities and so on may be characterized in terms of reachability (yes/no), efficiency (time or quality metrics), healthy (error logs, utilization levels, alarm/warning indications etc.) and so on.

Reachability, efficiency, health and other metrics associated with virtual entities and routes therebetween provide extremely useful information for managing a data center as well as the various virtual and nonvirtual entities therein. Further, by testing reachability between various entities, the most efficient routes between those entities and other entities may be determined.

In various embodiments, reachability information pertaining to some or all of the virtual machines or routes is continually gathered via reachability testing. Identified routes offering improved performance with respect to existing routes may be used instead of the existing routes by migrating virtual machines or various virtual components supporting the virtual machines as appropriate. In this manner, data center efficiency is continually improved.

Various management modules may be used to process data and provide information pertaining to reachability, efficiency and health to automated auditing systems, in response to customer inquiries and so on.

In various embodiments, policy-based alarms are used to define acceptable ping times in terms of reachability, efficiency and health. Such policies may comprise customer specific policies, tenant specific policies, service provider specific policies, traffic specific policies, priority based policies and so on. As an example, a ping related customer query may be associated with determining whether or not an appropriate level of service is being received, such as defined within a service level agreement. Policy-based criteria may be applied to any customer query. In various embodiments, the reachability engine may be used to implement this function.

In various embodiments, access to the reachability engine may be provided as a service to customers, system operators, service operators and the like via an application programming interface (API) or other means. For example, a customer provided query to the reachability engine may be formed in accordance with any of a number of formats, such as a query provided by a customer to [“reach VM UUIDx” from “source y”]. In response to this query, the reachability engine generates appropriate ping messages for testing reachability according to the customer-provided query as modified by any appropriate policies.

FIG. 8 depicts a flow diagram of a method according to one embodiment. Specifically, FIG. 8 depicts a flow diagram of a method 800 for obtaining reachability information in response to a customer/tenant query, such as via reachability engine access provided to a customer.

At step 810, a reachability query is received by the reachability engine, such as via a customer facing management module operative to receive customer queries pertaining to data center configuration, performance and operational status as it relates to that customer or tenant associated with that customer. Referring to step 815, it will be assumed that the customer facing manager module has screened or otherwise adapted the customer query to ensure that the reachability query provided to the reachability engine is appropriate to the customer, tenant or other source of the query and usable by the reachability engine.

At step 820, ping test vectors appropriate to satisfying the reachability query are generated. These test vectors may identify specific virtual machines, routes, protocols or any other virtual or nonvirtual entities relevant to satisfying the reachability query. For example, a query pertaining to virtual peer to peer operations may require status/reachability data associated with each of the virtual peers as well as any intervening networking/communication elements, whether virtual or nonvirtual. Thus, generating appropriate ping test vectors comprises identifying those entities necessary to pinging in order to gain the knowledge appropriate to the query. This discovery/topology information may be derived from information previously generated by the physical discovery and correlation engine 324, virtual discovery and correlation engine 325 or some other entity.

At step 830, the generated test vectors are adapted in accordance with policy-based criteria and, for example, may include appropriate responses for different types of virtual or nonvirtual entities, ranges of appropriate operation, definitions of various states that may be associated with different entities and so on. Policy information may also be used to add stress factors to replicate real world functions such as forcing additional data through channels being tested, stressing elements being tested using other elements, causing a reduction in capability of an element under test and so on. Thus, the adaptations contemplated with respect to step 830 may include causing virtual nonvirtual elements within the data center to stress those elements from which reachability information is to be obtained. Further, policy-based criteria may also comprise defining, in addition to or instead of ping tests, other tests to be run.

At step 840, reachability information is obtained using the test vectors and provided to the customer. For example, reachability information may be obtained using some or all of the steps 710-730 described above with respect to the method 700 of FIG. 7.

Service State And Alarm Correlation Engine

The service state and alarm correlation engine 328 may be used to process one or more received streams of alarm data or other service related data by correlating service alarms to particular problems within the data center, such as problems with particular VPLS, ToRs/EoRs, hypervisors, virtual switches, virtual machines and other virtual or nonvirtual entities. Using alarm stream information service state information and the like as discussed herein provides improved efficiency and management of real and virtual network elements, links, protocols, computation resources, memory resources, services, objects, virtual machines, VM-enabled appliances and so on within a data center environment. The service state and alarm correlation engine 328 may also be used to process state information and other information obtained or otherwise retrieved via operation of the reachability engine 327.

Since VMs can move/migrate between hypervisors (same or different racks), it is necessary to keep track of the state of the VMs and the related services. In this manner, ping data or alarm data may be processed with respect to VM state to determine if a real problem exists with the VM or any of the virtual or nonvirtual entities necessary to support the VM. For example, a PAUSED VM that is not reachable (i.e., associated with high ping data) may lead to triggering an alarm. However, since the PAUSED state is a valid state and a high ping is appropriate to this state, it is necessary to process any alarm to determine if the alarm is merely indicative of state-appropriate behavior.

VM states may be: MOVING, SHUT DOWN, RUNNING, PAUSED and so on. Some states are such that ping or other AOM tests will generate an alarm or fail event even though there is no failure. For example, partially provisioned (i.e., pre-provisioned) VMs waiting to be brought online in a day or two will possibly trigger non-reachability related alarms. As an example, assume that VMs are defined by a creation tool according to the following simplified format: (1) NIC card; (2) OS; (3) Network Id; (4) . . . . However, since the various parameters associated with the creation of the virtual machines are not yet necessarily known by other systems or management entities within the system, queries, pings, messages and so on transmitted to the partially provisioned virtual machines will likely yield incorrect responses from the perspective of the requesting entity.

A situation including partially provisioned virtual machines may occur within, illustratively, the context of fulfilling a customer order for a large number of VMs, or bringing online of one or more pods or data center portions, having different or nonstandard/unexpected hardware, software and services operable at different times and so on.

During this time of partial VM provisioning (or other anomalous conditions), alarms may be triggered that are correct in terms of the specific alarm state/parameters represented, however the underlying behavior/status of the entities from which the alarms are derived is entirely consistent with the state of the entity. Thus, an alarm may be triggered where the status of a VM is such that such an alarm should be triggered.

Various VM creation tools, such as the ARCHIPEL tool (part of CNA) may be used to define or create virtual machines, and do so in a staged or staggered manner. This is especially useful where multiple service providers are responsible for implementing data center functionality. A first server provider may install and test hardware components, such as the components of a pod. A second service provider may provide connectivity and various L2/L3 services to the equipment in the pod. A third service provider may take control of the equipment within the pod, the services associated equipment and so on to implement data center or other functionality. This staged rollout or implementation of functionality will likely result in a sequence of alarm conditions which are perfectly explainable within the context of the underlying status of the alarm entities.

A VM in a pause state is not reachable. An alarm indicative of the VM not being reachable is understandable within the context of the paused state. Data returned to a customer may indicate that the VM is unreachable but paused. Alternatively, a policy may indicate that an apparently unreachable VM that is paused does not generate alarm data for use by customer.

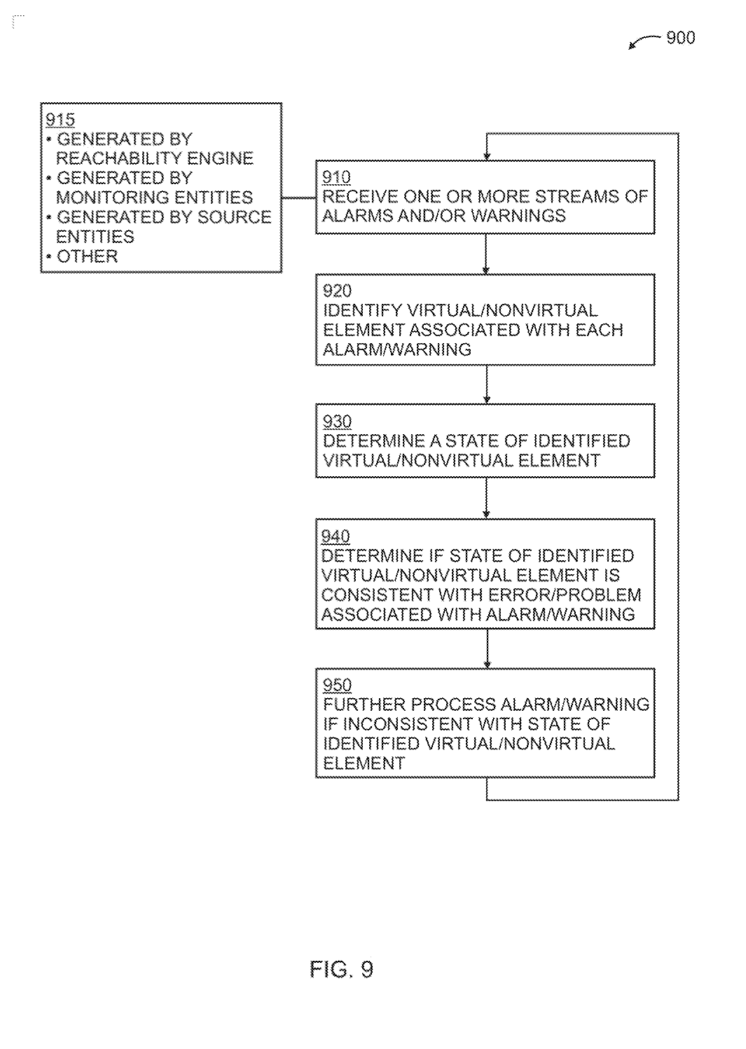

FIG. 9 depicts a flow diagram of a method according to one embodiment. Specifically, FIG. 9 depicts a flow diagram of a method 900 for intelligently correlating alarm information to service state information to determine thereby whether the alarm information should be processed further or discarded.

At step 910, one or more streams of alarms or warnings are received by, illustratively, the service state and alarm correlation engine 328.

At step 920, the virtual/nonvirtual element or elements associated with each alarm/warning is identified.

At step 930, the state of the identified virtual/nonvirtual element or elements is determined.

At step 940, a determination is made as to whether the state of the identified virtual/nonvirtual element is consistent with the error or problem associated with the corresponding alarm/warning.

At step 950, if the state of the identified virtual/nonvirtual element is inconsistent with the error or problem associated with the corresponding alarm/warning, then the alarm/warning is subjected to further processing. Otherwise, the alarm/warning is discarded or deemed to be unrelated to an error or problem.

In one embodiment, all data associated with generated alarms/warnings as well as the entities generating those alarms/warnings are provided to the customer. That is, some or all of the raw data associated with alarm/warning conditions, an entity identifier or status of the entity or entities generating the alarm/warning conditions, associated entities or other selected information may be provided directly to a requesting customer or tenant. Raw data to be provided may be defined within the context of a policy, or customer requirement, or service provider requirements and the like.

In another service alarm correlation embodiment, data associated with generated alarms and the entities associated with those alarms is only provided to the customer where the alarm does not make sense in view of the status of the entity associated with the alarm. That is, interpreted, validated or otherwise qualitatively processed (raw) data associated with alarm/warning conditions may be provided to the customer. Interpreted data to be provided may be defined within the context of a policy, or customer requirement, or service provider requirements and the like.

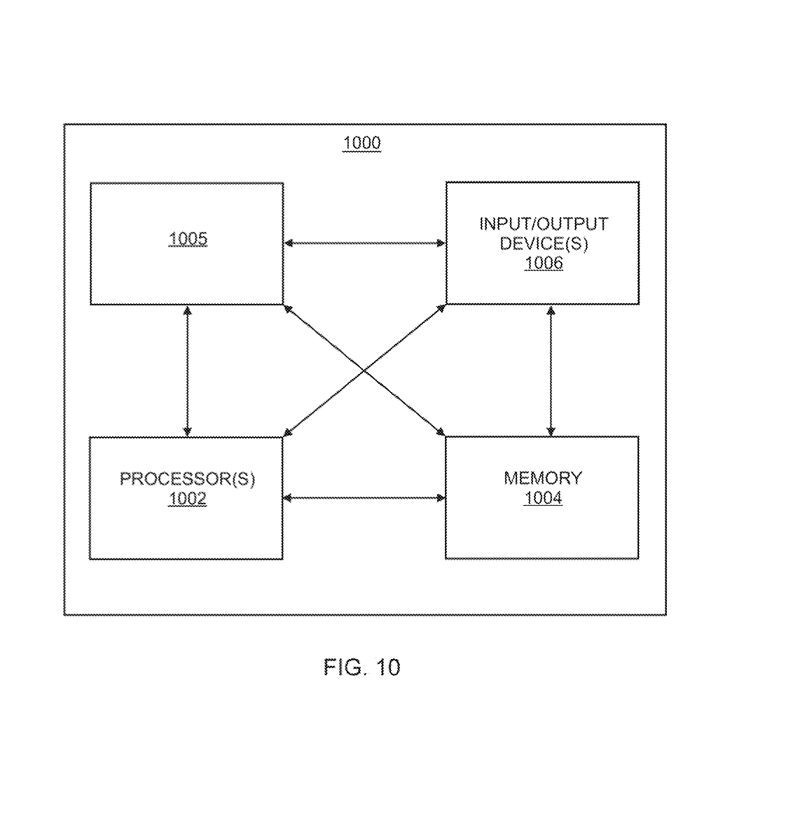

FIG. 10 depicts a high-level block diagram of a computing device, such as a processor in a telecom network element, suitable for use in performing functions described herein such as those associated with the various elements described herein with respect to the figures.

In particular, one or more management, network, communication or resource allocating elements such as within or coupled to a data center may be used to implement, individually or in any combination, the MS programming module 332, physical discovery and correlation engine 324, virtual discovery and correlation engine 325, cloud entity manager 326, reachability engine 327 or service state and alarm correlation engine 328 using software instructions which may be executed by a processor (e.g., processor(s) 310) within the relevant one or more management, network or communication elements.

As depicted in FIG. 10, computing device 1000 includes a processor element 1003 (e.g., a central processing unit (CPU) or other suitable processor(s)), a memory 1004 (e.g., random access memory (RAM), read only memory (ROM), and the like), a cooperating module/process 1005, and various input/output devices 1006 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware or in a combination of software and hardware, e.g., using a general purpose computer, one or more application specific integrated circuits (ASIC), or any other hardware equivalents. In one embodiment, the cooperating process 1005 can be loaded into memory 1004 and executed by processor 1003 to implement the functions as discussed herein. Thus, cooperating process 1005 (including associated data structures) can be stored on a computer readable storage medium, e.g., RAM memory, magnetic or optical drive or diskette, and the like.

It will be appreciated that computing device 1000 depicted in FIG. 10 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method of managing virtual and nonvirtual elements in a data center (DC), comprising:
determining nonvirtual DC elements and connections necessary to support at least one L3 service;
identifying, for the at least one L3 service, at least one access point supporting an L2 service communicating with a virtual machine (VM);
correlating the VM with nonvirtual DC elements and connections necessary to support the L2 service communicating with the VM; and
storing, in a non-transient memory, correlation data associated with the VM.

2. The method of claim 1, wherein correlating includes correlating the VM with nonvirtual DC elements and connections necessary to support the L3 service supporting the L2 service communicating with the VM.

3. The method of claim 1, wherein identifying includes repeatedly examining L3 services within the DC to identify respective attached L2 services communicating with hypervisors.

4. The method of claim 1, wherein determining includes retrieving configuration and connections information for nonvirtual DC elements to be managed.

5. The method of claim 4, further comprising discovering configuration and connections from at least one server including a hypervisor.

6. The method of claim 1, wherein identifying L3 access points supporting L2 services communicating with the VM includes retrieving L2/L3 correlation information from a correlation database.

7. The method of claim 6, wherein each L3 access point is associated with a respective identifier, said L2/L3 correlation information being generated by repeatedly identifying, for each L2 service, a respective L3 access point identifier indicative of the correlated L3.

8. The method of claim 6, wherein generating L2/L3 correlation information for the correlation database includes:
identifying, for each of a plurality of L3 services, respective L3 access interfaces, each of the L3 access interfaces being associated with a respective identifier;
for each of the identified L3 services, using the respective identifier to determine any L3 or L2 services connected to the identified L3 service; and
correlating to each identified L3 access interface any respective identified L3 or L2 services connected thereto;
adapting data center management in response to said correlation between virtualized L3 and L2 services.

9. The method of claim 1, wherein said VM is correlated with a virtual port attached to a corresponding L2 service.

10. The method of claim 9, wherein said L2 service comprises a virtual L2 service, and said L3 service comprises a nonvirtual L3 service.

11. The method of claim 9, wherein said L2 service comprises a virtual L2 service, and said L3 service comprises a virtual L3 service in communication with a nonvirtual L3 service, wherein said determining includes determining virtual and nonvirtual DC elements and connections necessary to support the virtual L3 service.

12. The method of claim 1, wherein at least one of said L3 services comprises a virtual L3 service, wherein said determining includes determining virtual and nonvirtual DC elements and connections necessary to support the virtual L3 service.

13. The method of claim 11, wherein the virtual L3 service is supported by a nonvirtual L3 service, wherein said determining includes determining virtual and nonvirtual DC elements and connections necessary to support each of the virtual and nonvirtual L3 services.

14. The method of claim 1, wherein the method is performed via a Management System (MS) in communication with the DC and operative to correlate L2/L3 services to respective virtual and nonvirtual elements necessary to support the L2/L3 services.

15. The method of claim 1, wherein the method is performed via a Cloud Entity Manager (CEM) in communication with at least a portion of the DC and operative to correlate L2/L3 services to respective virtual and nonvirtual elements within the respective portion of the DC.

16. The method of claim 15, wherein the portion of the DC associated with a CEM comprises a modular DC component including at least one resource cluster.

17. An apparatus for managing virtual and nonvirtual elements in a data center, the apparatus comprising:
a processor configured for:
determining nonvirtual DC elements and connections necessary to support at least one L3 service;
identifying, for the at least one L3 service, at least one access point supporting an L2 service communicating with a virtual machine (VM);
correlating the VM with nonvirtual DC elements and connections necessary to support the L2 service communicating with the VM; and
storing, in a non-transient memory, correlation data associated with the VM.

18. The apparatus of claim 17, wherein correlating includes correlating the VM with nonvirtual DC elements and connections necessary to support the L3 service supporting the L2 service communicating with the VM.

19. The apparatus of claim 17, wherein the apparatus comprises a Management System (MS) in communication with the DC and operative to correlate L2/L3 services to respective virtual and nonvirtual elements necessary to support the L2/L3 services.

20. The apparatus of claim 17, wherein the apparatus comprises a Cloud Entity Manager (CEM) in communication with at least a portion of the DC and operative to correlate L2/L3 services to respective virtual and nonvirtual elements within the respective portion of the DC.

21. The apparatus of claim 20, wherein the portion of the DC associated with a CEM comprises a modular DC component including at least one resource cluster.

22. A tangible and non-transient computer readable storage medium storing instructions which, when executed by a computer, adapt the operation of the computer to perform a method for managing virtual and nonvirtual elements in a data center (DC), the method comprising:
determining nonvirtual DC elements and connections necessary to support at least one L3 service;
identifying, for the at least one L3 service, at least one access point supporting an L2 service communicating with a virtual machine (VM);
correlating the VM with nonvirtual DC elements and connections necessary to support the L2 service communicating with the VM; and
storing, in a non-transient memory, correlation data associated with the VM.

23. A computer program product comprising a non-transitory computer readable medium storing instructions for causing a processor to implement a method for managing virtual and nonvirtual elements in a data center (DC), the method comprising:
determining nonvirtual DC elements and connections necessary to support at least one L3 service;
identifying, for the at least one L3 service, at least one access point supporting an L2 service communicating with a virtual machine (VM);
correlating the VM with nonvirtual DC elements and connections necessary to support the L2 service communicating with the VM; and
storing, in a non-transient memory, correlation data associated with the VM.
